(19) United States
(12) Patent Application Publication
(10) Pub. No.: US 2022/0050504 A1
(43) Pub. Date: Feb. 17, 2022

(54) Twin Display Point of Sale Device

(71) Applicant: Barclays Execution Services Limited, London (GB)

(72) Inventor: Usman SHEIKH, London (GB)

(73) Assignee: Barclays Execution Services Limited, London (GB)

(21) Appl. No.: 17/416,922

(22) PCT Filed: Dec. 20, 2019
(86) PCT No.: PCT/GB2019/053647

§ 371 Date: Jun. 21, 2021

(30) Foreign Application Priority Data
Dec. 21, 2018 (GB) 1821028.6

(51) Int. Cl. G06F 1/16; G07G 1/00; G07G 1/12

(52) U.S. Cl. CPC G06F 1/1649; G07G 1/0018; G07G 1/0036; G06F 1/1681; G06F 1/1618; G07G 1/12

(57) ABSTRACT

A point of sale (POS) device comprises: a base; a first display panel hinged on one end of the base; and a second display panel hinged on an opposite end of the base. The first and second display panels may be hinged to the base such that, in an operational configuration, an end of the first display panel distal the base meets an end of the second display panel distal the base. The base may be relatively planar and the one end of the base spaced apart from the plane of the base such that, in a stowed configuration, the second display panel can fold to lie flat against the base and the first display panel can fold to lie flat against the second display panel.

### TECHNICAL FIELD OF THE DISCLOSURE

The present disclosure relates to point of sale devices.

### BACKGROUND TO THE DISCLOSURE

Mobile businesses, such as single-person businesses, have become increasingly popular in recent years and a large segment of the payments industry now consists of micro-merchants. Mobile point of sale solutions, including point of sale software (developed by, for example, Toast, Inc., Square, Inc. Epos Now and Lightspeed) for smartphones and tablets, and chip and PIN/contactless card terminals (for example, PIN pads by Verifone and card readers by iZettle) are replacing traditional cash registers in many establishments, and particularly in the mobile businesses sector, since cash registers are cumbersome and have to be tethered to one location.

Smartphones and tablets are, however, general purpose devices and can therefore have limited functionality as point of sale solutions. For example, when a mobile point of sale solution is not able to accept near field communication (NFC) payments, separate credit card readers that attach to the phone or tablet may have to be provided. Not to mention, mobile point of sale software can sometimes only be used with a subscription. A single screen further limits the functionality, since merchants and customers cannot use the device simultaneously.

GB 2505867 A describes a design of a modular POS system having single base portion and two receiving portions, each configured to receive a portable device and thereby provides two displays. Such a system is suited to a business with a more fixed operation.

It would therefore be desirable if a more efficient and seamless point of sale solution could be provided to improve the point of sale experience of merchants (particularly mobile merchants) and their customers, particularly for mobile businesses.

### SUMMARY OF THE DISCLOSURE

Against this background, there is provided a point of sale device comprising: a base; a first display panel hinged on one end of the base; and a second display panel hinged on an opposite end of the base. Advantageously, the first and second display panels are hinged to the base such that, in an operational configuration, an end of the first display panel distal the base meets (that is, touches, couples and/or cooperates with) an end of the second display panel distal the base.

With the provision of two display panels in an operational configuration, this allows more than one user (such as a merchant and a customer, for example) to use the point of sale device at the same time, efficiently and seamlessly, and without the need to pass the device around. The device may be robust for use operational configuration thereby, in which the merchant and/or customer may interact (by viewing and/or touching) the display panels. In addition, by having the first and second display panels hinged on either side of a base, this provides a flexible and adaptable point of sale device. The base, first display panel and second display panel are advantageously of planar form.

Preferably, the base is relatively planar and the one end of the base is spaced apart from the plane of the base such that, in a stowed configuration, the second display panel can fold (through the hinged configuration) to lie flat against the base and the first display panel can fold (through the hinged configuration) to lie flat against the second display panel. In this way, when the device is not being operated, the device can be compactly stored and transported with ease. More preferably, the one end of the base is spaced apart from the plane of the base by a depth dimension of the second display panel (the depth dimension being perpendicular to the plane of the second display panel).

Preferably the base is configured to sit on a working surface and in the operational configuration, support the first and second display panels to be spaced apart from the working surface. In particular, the plane of the base, the plane of the first display panel and the plane of the second display panel form a triangular cross-section in the operational configuration.

The first and second display panel are preferably configured such that, in an operational configuration, an angle between the first display panel and the base is less than an angle between the second display panel and the base. In this way, in operation, the second display panel can be more upright than the first display panel. Preferably, the angle between the first display panel and the base is from about 30° to about 60° and the angle between the second display panel and the base is from about 50° to about 80°. Preferably, the angle between the first display panel and the base is from about 40° to about 50° and the angle between the second display panel and the base is from about 65° to about 75°.

Preferably, the first display panel and second display panel are arranged to face outwardly from the base in the operational configuration. In some cases, a length of the first display panel elongated away from the one end of the base may be longer than a length of the second display panel elongated away from the opposite end of the base.

In some cases, the ends of the first and second display panels distal the base may be operable to engage magnetically. In this way, a seamless means for coupling the first display panel to the second display panel, in an operational configuration, is provided. Preferably, the first display panel is configured to be used by a merchant and the second display panel is configured to be used by a customer.

In some cases, the end of the first display panel distal the base comprises a Near Field Communication (NFC) device. Preferably, the base houses a tray which is arranged to be slid in and out of an opening of the base. In such a case, the opening of the base is preferably at an end of the base adjacent the second display panel. In some cases, the tray may comprise a slot at the end of the base adjacent the second display panel for receiving a card. In some cases, the tray may contain a chip and PIN device.

Preferably, each of the first and second display panel comprises a respective touch screen display.

The device is preferably configured to be portable and more preferably, handheld. The device may comprise a housing made of plastic. The base preferably includes at least one battery. Preferably, the point of sale device further comprises a coupling connector for receiving electrical power to charge the battery. In this way, the device can conveniently be charged.

Preferably, the point of sale device further comprises: at least one processor; and a memory storing at least one processing program, wherein the processing program is configured to control operation of the first and second display panels. In this case, the processor is preferably in the base of the point of sale device.

It is to be understood that, although the terms first, second etc. may be used herein to describe various elements, these elements should not be limited by these terms. These terms are only to distinguish one element from another. As used herein, the term “meets” could also be understood to mean “cooperates”, “connects” and “couples to”. Combinations and sub-combinations of specific features disclosed herein are also provided, except where features are mutually exclusive.

### BRIEF DESCRIPTION OF THE FIGURES

The preferred embodiment of the invention will now be described by way of example only and with reference to the accompanying drawings, in which:

FIG. 1A shows a side view of the point of sale device in the operational configuration;

FIG. 1B shows a three-dimensional view of the point of sale device in the operational configuration;

FIG. 2A shows a side view of the point of sale device in the stowed configuration;

FIG. 2B shows a three-dimensional view of the point of sale device in the stowed configuration;

FIG. 3A shows the dimensions of the point of sale device, housing a tray, and the angles between base and the first and second display panels;

FIG. 3B shows a three-dimensional view of the point of sale device, housing a tray, in the operational configuration; and

FIG. 4 shows a front view of a display panel of the point of sale device.

### DETAILED DESCRIPTION OF PREFERRED EMBODIMENTS

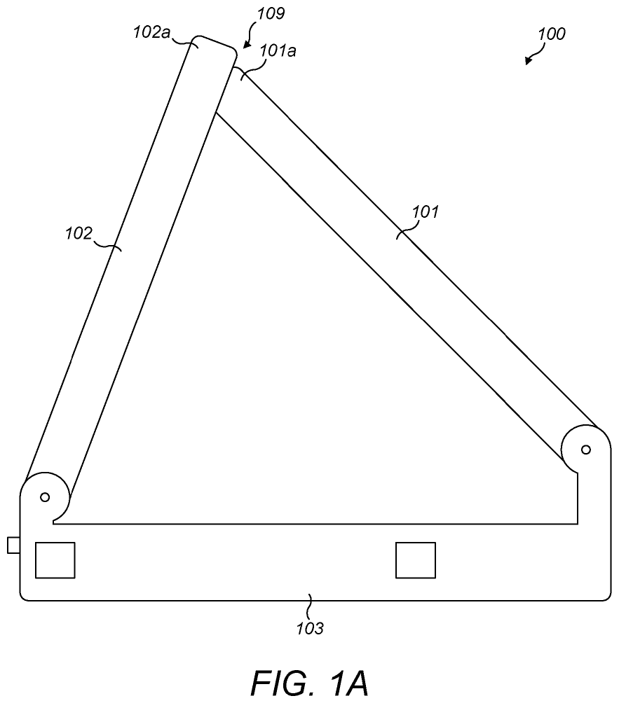

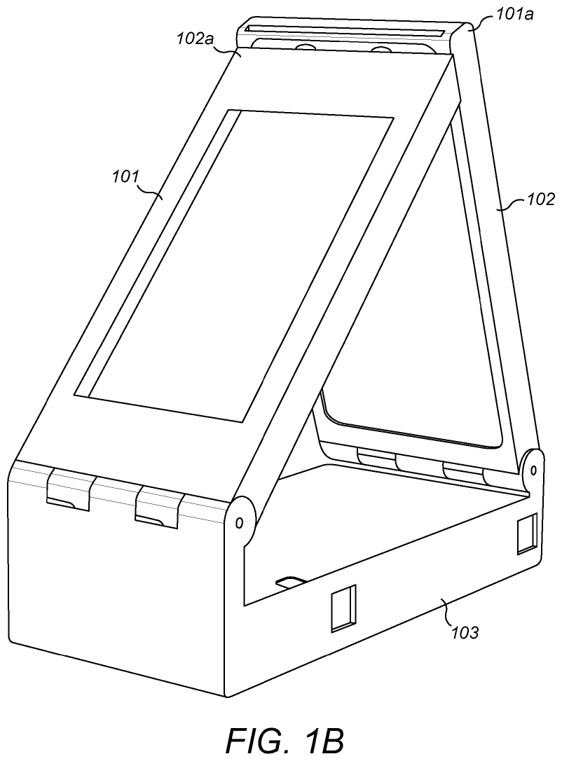

With reference to the accompanying FIGS. 1-4, wherein like reference numerals designate like or corresponding parts throughout the several views, the present invention is explained hereafter.

FIGS. 1A and 1B show a point of sale (herein abbreviated POS) device 100 in an operational configuration according to an embodiment of the present invention. The POS device 100 is configured to be portable and is particularly suited for use by mobile businesses. It will be readily apparent, however, that the POS device 100 can also be used in other settings, such as retail establishments, for example.

The POS device 100 comprises a base 103. A first display panel 101 is hinged on one end of the base 103 and a second display panel 102 is hinged on an opposite end of the base 103. As best seen in FIGS. 1A and 1B, in an operational configuration, an end of the first display panel distal the base 101a meets an end of the second display panel distal the base 102a. An operational configuration, as used in this application, is a configuration of the POS device 100 adapted to facilitate a financial transaction. The base 103 is configured to sit on a working surface and in the operational configuration, support the first and second display panels to be spaced apart from the working surface.

In the operational configuration, the ends of the first and second display panels distal the base may be operable to engage magnetically. As an example, the ends of the first and second display panels distal the base may each comprise a magnet. Alternatively, the end of the first display panel distal the base 101a may comprise a magnet and the end of the second display panel distal the base 102a may comprise a ferromagnetic material, or vice versa. The operational configuration is described in greater detail below.

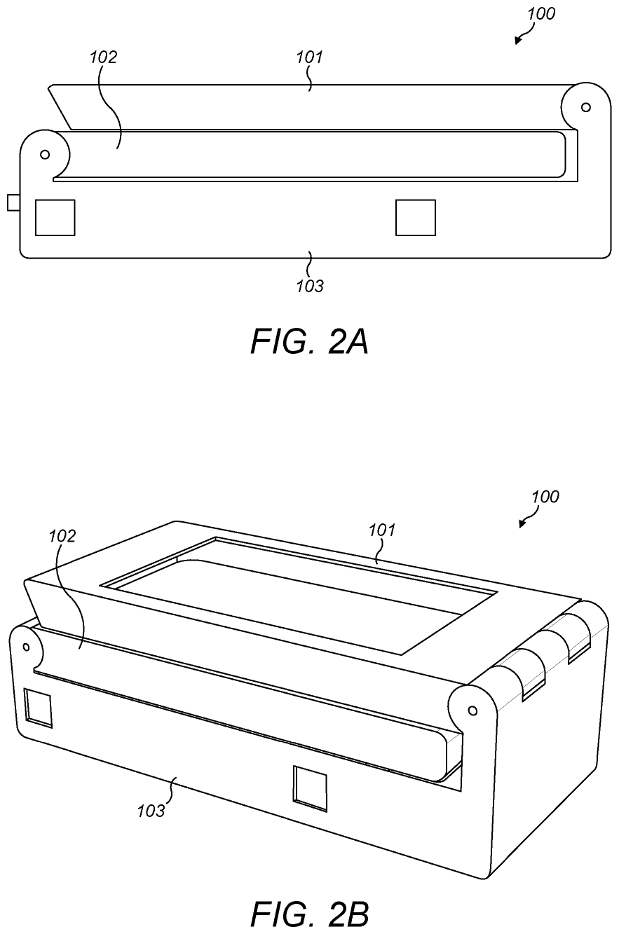

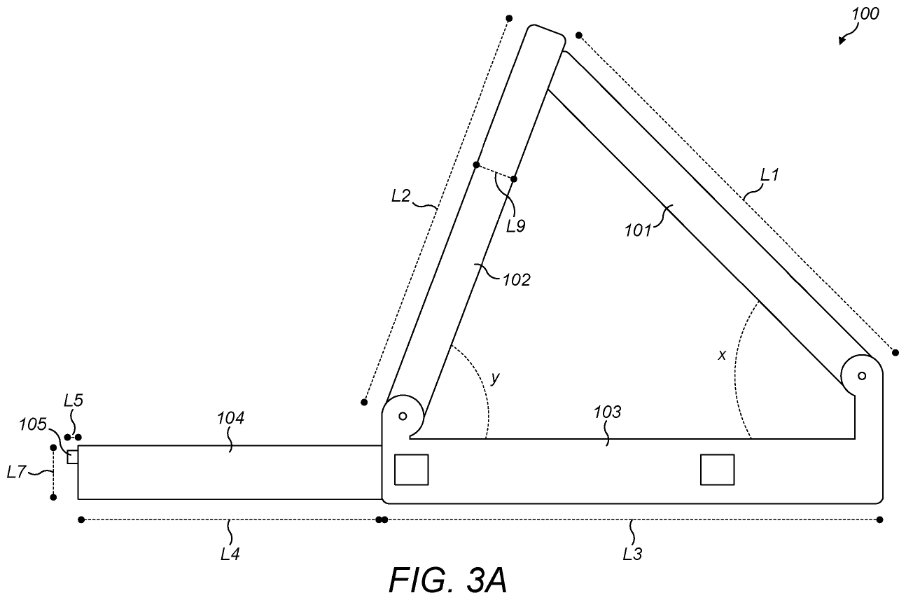

The one end of the base 103 may be spaced apart from the plane of the base 103 such that, in a stowed configuration, as shown in FIGS. 2A and 2B, the second display panel 102 can fold to lie flat against the base 103 and the first display panel 101 can fold to lie flat against the second display panel 102. The first and second display panels of the POS device 100 can be moved through a range of positions, between the operational configuration (FIG. 1) and the stowed configuration (FIG. 2). The hinging mechanism used for hinging the first and second display panels on the one end and the opposite end of the base, respectively, may include, for example, pin type hinges, pin and socket type hinges, ball and socket type hinges or elastic hinges. The POS device 100 may fold to a third of its size in the stowed configuration, relative to its size in the operational configuration. The foldable and compact POS device 100 provides an easily transportable POS solution for mobile merchants.

The housing of the POS device 100 may be made of a lightweight material such as plastic, or the like. The first display panel 101 and second display panel 102 may be arranged to face outwardly in the operational configuration. The first display panel 101 may be configured to be used by a merchant and the second display panel 102 may be configured to be used by a customer. The end of the second display panel distal the base 102a may comprise a Near Field Communication (herein abbreviated NFC) device, such that the POS device 100 can perform communication with an external electronic device, such as a smartphone, which may belong to a customer, for example.

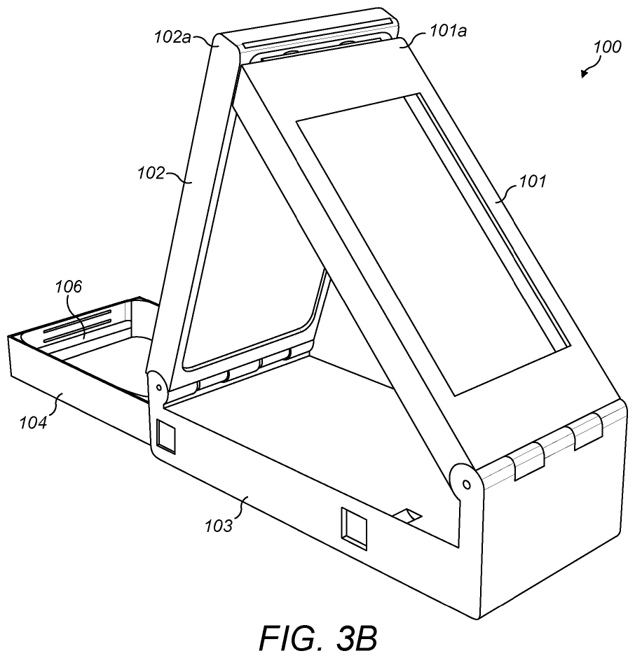

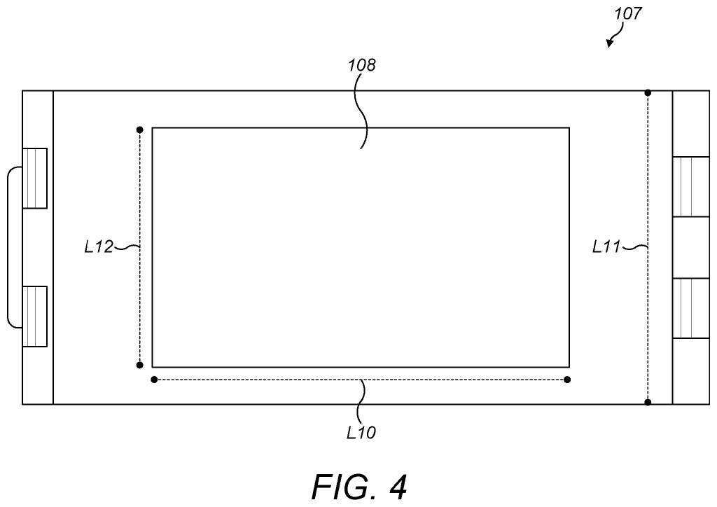

As shown in FIG. 3A, in the operational configuration, an angle x between the first display panel 101 and the base 103 may be less than an angle y between the second display panel 102 and the base 103. This provides that the second display panel 102 is more upright than the first display panel 101 such that, the second display can be used by a customer with ease and efficiency. The angle x may be from about 30° to about 60° and the angle y may be from about 50° to about 80°. Preferably, the angle x may be from about 40° to about 50° and the angle y may be from about 65° to about 75°. For example, the angle x may be about 47° and the angle y may be about 70.6°.

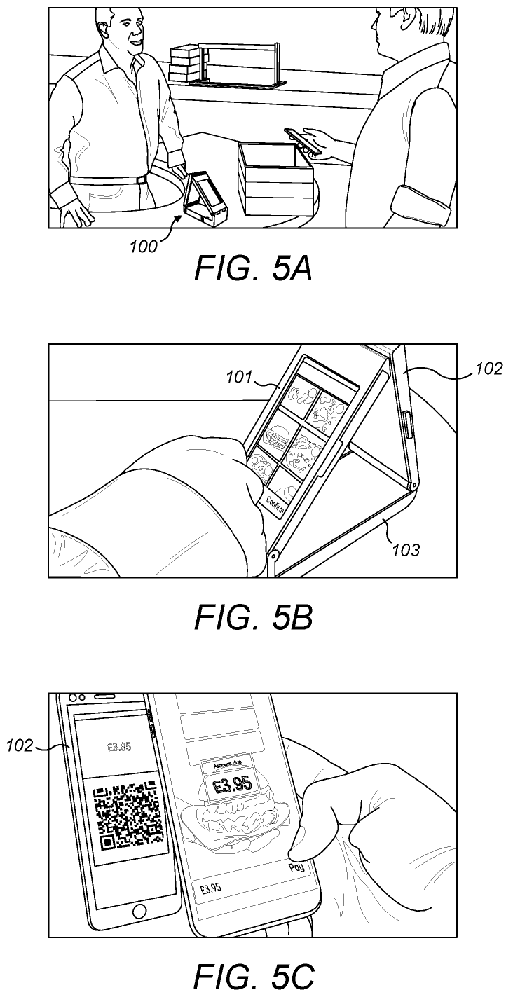

With reference to FIG. 3A, a length L1 of the first display panel 101 elongated away from the one end of the base may be longer than a length L2 of the second display panel 102 elongated away from the opposite end of the base. For example, L1 may be about 160 millimetres and L2 may be about 151 millimetres. The depth L9 and width L10 (FIG. 4) of the first and second display panels may be the same such that, a surface area of the first display panel, which may be configured to be used by a merchant, is larger than a surface area of the second display panel, which may be configured to be used by a customer. A length L3 of the base from the one end to the opposite end may be longer than both the length L1 of the first display panel 101 and the length L2 of the second display panel 102. For example, L3 may be about 178 millimetres. The length L8 of the one end of the base 103 spaced apart from the plane of the base 103 may be shorter than L1, L2 and L3. For example, L8 may be about 57 millimetres.

The POS device 100 shown in FIGS. 3A and 3B houses a tray 104 (within a hollow part of the base 103), which is arranged to be slid in and out of an opening of the base 103. Preferably, the opening of the base 103 is at an end of the base 103 adjacent the second display panel 102, such that the tray 104 may be easily accessible for a customer. A handle 105 may be provided to facilitate movement of the sliding tray. The length L5 of the handle 105 elongated away from an end proximal the tray 104 may be about 5 millimetres, for example. With reference to FIG. 3A, the tray 104 may extend a length L4 outwards from the opening of the base 103. For example, the length L4 may be about 126 millimetres. The tray 104 may have a depth L7 of about 19 millimetres.

As shown in FIG. 3B, the tray 104 comprises a slot 106 at the end of the base 103 adjacent the second display panel 102 for receiving a card, to facilitate card payment transactions. The tray 104 may contain a chip and PIN device, such as “Barclaycard Anywhere”, or the like, to further facilitate card payment transactions. Square shapes on the side of the base 103 (visible in each of FIGS. 1A to 3B) represent indents for the tray 104 to lock into (one for an open position and a second for when closed). In addition, or (more likely) as an alternative to using such indents, the tray 104 may be spring-loaded.

The POS device 100 may further comprise at least one processor; and a memory storing at least one processing program, wherein the processing program is configured to control operation of the first and second display panels. The base 103 may comprise the at least one processor. Each of the first and second display panels of the POS device 100 may comprise a respective touch screen display 108. With reference to FIG. 4, an example display panel 107 is shown. A user may enter information using the touch screen display 108, which can be processed by the processor. The first display panel 101 may display a Merchant app and the second display panel 102 may display a Customer app.

The touchscreen may be substantially rectangular. The length L10 of the touch screen display 108 may be shorter than the length L1 of the first display panel 101 and the length L2 of the second display panel 102. For example, the length L10 of the touch screen display 108 may be about 110 millimetres. The width L12 of the touch screen display 108 may be less than the width L10 of the first and second display panels. For example, the width L11 of the touch screen display 108 may be about 62 millimetres.

The base 103 of the POS device 100 may also include at least one battery. The battery life may be approximately an ‘All Day’ charge. The POS device 100 may further comprise a coupling connector, such as a micro USB, for receiving electrical power to charge the at least one battery.

Although specific embodiments have now been described, the skilled person will appreciate that various modifications and alternations are possible. For example, specific measurements and positions may be varied in practice. Different types of electronic component may be employed. Software and/or usage may differ between applications and implementations.

1. A point of sale, POS, device comprising:
a base;
a first display panel;
a second display panel; and
a hinging mechanism;
wherein the first display panel is hinged on one end of the base via the hinging mechanism, and the second display panel is hinged on an opposite end of the base via the hinging mechanism;
wherein each of the first and second display panel comprises a respective touch screen display;
wherein the first and second display panels are hinged to the base such that, in an operational configuration, an end of the first display panel distal the base meets an end of the second display panel distal the base, and
wherein the base is relatively planar and the one end of the base is spaced apart from the plane of the base such that, in a stowed configuration, the second display panel can fold to lie flat against the base and the first display panel can fold to lie flat against the second display panel.

2. The POS device of any preceding claim, wherein the base is configured to sit on a working surface and in the operational configuration, support the first and second display panels to be spaced apart from the working surface.

3. The POS device of any preceding claim, wherein the first and second display panel are configured such that, in the operational configuration, an angle between the first display panel and the base is less than an angle between the second display panel and the base.

4. The POS device of claim 3, wherein the angle between the first display panel and the base is from about 30° to about 60° and the angle between the second display panel and the base is from about 50° to about 80°.

5. The POS device of claim 3 or claim 4, wherein the angle between the first display panel and the base is from about 40° to about 50° and the angle between the second display panel and the base is from about 65° to about 75°.

6. The POS device of any preceding claim, wherein the first display panel and second display panel are arranged to face outwardly from the base in the operational configuration.

7. The POS device of any preceding claim, wherein a length of the first display panel elongated away from the one end of the base is longer than a length of the second display panel elongated away from the opposite end of the base.

8. The POS device of any preceding claim, wherein the ends of the first and second display panels distal the base are operable to engage magnetically.

9. The POS device of any preceding claim, wherein the first display panel is configured to be used by a merchant and the second display panel is configured to be used by a customer.

10. The POS device of any preceding claim, wherein the end of the second display panel distal the base comprises a Near Field Communication, NFC, device.

11. The POS device of any preceding claim, wherein the base houses a tray which is arranged to be slid in and out of an opening of the base.

12. The POS device of claim 11, wherein the opening of the base is at an end of the base adjacent the second display panel.

13. The POS device of claim 12, wherein the tray comprises a slot at the end of the base adjacent the second display panel for receiving a card.

14. The POS device of any of claims 11-13, wherein the tray contains a chip and PIN device.

15. The POS device of any preceding claim, wherein the device is configured to be portable.

16. The POS device of any preceding claim, wherein the device comprises a housing made of plastic.

17. The POS device of any preceding claim, wherein the base includes at least one battery.

18. The POS device of claim 17, wherein the device further comprises a coupling connector for receiving electrical power to charge the at least one battery.

19. The POS device of any preceding claim, further comprising:
at least one processor; and
a memory storing at least one processing program,
wherein the processing program is configured to control operation of the first and second display panels.

20. The POS device of claim 19, wherein the at least one processor is in the base.
